(19) United States
(12) Patent Application Publication
(10) Pub. No.: US 2012/0121348 A1
(43) Pub. Date: May 17, 2012

(54) BORING TOOL AND METHOD FOR CYLINDER BORES

(75) Inventors: Dennis Eckert, Nieder-Olm (DE); Michael Lahres, Neu-Ulm (DE); Oliver Neufang, Blaustein (DE); Andreas Wiens, Bietigheim-Bissingen (DE); Kevin Nedzlek, Howell, MI (US)

(73) Assignee: DAIMLER AG, Stuttgart (DE)

(21) Appl. No.: 12/946,021

(22) Filed: Nov. 15, 2010

(51) Int. Cl. B23B 41/12; B23B 47/18; B23B 35/00; B23B 51/06

(52) U.S. Cl. 408/1 R; 408/56; 408/147; 408/129

(57) ABSTRACT

A boring tool for boring cylinder bores (6), with a tool holder (8) and a tool head (4) with a cutting edge carrier for at least one cutting edge (3) and with a rotary drive for driving the at least one cutting edge (3). The cutting edge carrier is provided with a first, preferably hydraulic, adjusting device for the adjustment of a variable cutting radius of the cutting edge (3), a ring module for first support rails (1), which concentrically surrounds the tool head (4), a second adjusting device for the variable radial adjustment of the supporting radius of the first support rails (1), and a third adjusting device for variable radial adjustment of a supporting radius of second support rails (2). The tool head (4) is axially moveable within the ring module. A method for boring cylinder bores (6) involving the use of the boring tool is disclosed as well.

The invention relates to a boring tool and to a method for the high-precision boring of cylinder bores.

Cylinder sliding surfaces in crankcases are nowadays usually coated, for example in a thermal spraying process such as arc spraying. Up to now, the coated cylinder working surface has been machined over its entire length, and owing to the coating, the machining process had to be centered accurately. Thermally coated cylinders are at present usually machined in a cost-intensive rough honing process which involves relatively long machining times and the use of expensive honing machines.

DE 103 58 150 A1, for example, describes a method for honing bores having a hardened section. This honing process is said to be more efficient and to result in a higher dimensional accuracy. The method described there relates to a bore which has two axially consecutive and possibly not concentric sections with different hardness of the surfaces to be machined. For honing this bore, the honing tool is radially supported in one of the sections by means of guide rails, while the other, hardened section of the bore is honed by the honing rail of the tool. The infeed of the guide rails is independent of the honing rails, wherein the honing rails are feed in by electro-mechanical power and the working stroke of the honing tool is changed continuously, the honing tool being expanded in accordance with a defined infeed mode.

From DE 199 50 168, a method for producing cylinder sliding surfaces and a device for executing the method are known, which aim at producing cylinder sliding surfaces of high quality and accuracy. The cylinder sliding surfaces are finished by means of a multiple-edged tool the cutting edges of which act simultaneously on the cylinder sliding surface. The axis of the multiple-edged tool coincides with the axis of symmetry of the cylinder sliding surface to be machined. The cutting tool is fitted with an expanding ring allowing an irreversible expansion of the outer cutting edges.

DE 102 41 446 A1 discloses a method for the rough and finish machining of a hollow cylinder which uses rotating tools. The tools rotate independently but simultaneously on a common axis, the finishing tool executing an oscillating stroke movement which is independent of the rough machining tool. An inner tool carrier is provided with a fluid passage for both tools and has an annular passage with radial bores to feed the machining fluid from the fluid passage to the tool carriers.

On the basis of this prior art, the present invention is based on the problem of providing a self-centering tool which allows the precise boring of cylinder bores in a cost-effective manner.

This problem is solved by the boring tool with the features of claim 1.

The invention is further based on the problem of creating a method for the precise boring of cylinder bores which provides for shorter machining times and lower machining costs than the rough honing processes of prior art. This problem is solved by the method with the features of claim 7.

A first embodiment of the boring tool according to the invention for cylinder bores relates to a tool with a tool holder and a tool head, the tool head comprising a cutting edge carrier with a rotary drive for one or more cutting edges. The tool head further comprises a fluid supply device. In order to allow the precise boring of the cylinder bores according to the invention, the boring tool according to the invention is fitted with a cutting edge carrier which advantageously comprises an adjusting device for the adjustment of a variable cutting radius of the cutting edge(s). For advantageous self-centering, the tool is further provided with a ring module which concentrically surrounds the tool head and which comprises first support rails.

The ring module is advantageously likewise provided with an adjusting device for the variable adjustment of the supporting radius of the first support rails. Finally, the tool comprises on the ring module a third adjusting device for the second support rails, which is provided for the variable radial adjustment of the second support rails. The three adjusting devices are operatively coupled to the fluid supply device, so that the adjusting devices operate hydraulically, while the tool head can be traversed axially with respect to the ring module.

The boring tool according to the invention with the flexible adjusting facilities therefore provides a cost-effective finish-cutting machine which allows a precise boring of the cylinder bores owing to the self-centering facility provided by the first and second support rails. Such cylinder bores may be thermally coated cylinder bores.

The tool head may moreover be designed such that it cannot only be traversed axially with respect to the ring module, but also with respect to the tool carrier.

For the desirable precise centering, it is further advantageous if the ring module has at least three first and three second support rails of equidistant distribution along the circumference of the ring module. The first and second support rails may be offset relative to each other. These support rails distributed evenly along the circumference of the ring module allow the precise centering of the tool head in the cylinder bore, so that the central tool axis coincides with the central axis of the cylinder bore.

The boring tool may conceivably have only one cutting edge, but in a preferred embodiment, the cutting edge carrier is fitted with four cutting edges distributed evenly along its circumference. Other numbers of cutting edges are also conceivable, as long as they are distributed evenly along the circumference of the cutting edge carrier. The cutting edges may be interchangeable inserts.

The fluid for the operation of the adjusting devices, which is supplied by the preferably axial fluid supply device, may be a cooling lubricant which can be used both for cooling and for lubricating the boring process.

Owing to its self-centering design, which provides for precise boring, the boring tool according to the invention is particularly suitable for thermally coated cylinder bores such as arc-sprayed cylinder bores. These cylinder bores typically have at the end which is remote from the cylinder opening a circumferential spindle lead-out with a diameter which is greater than the diameter of the cylinder bore.

The method according to the invention, which uses the boring tool, involves lower machining costs than a rough honing process, and machining times are shorter as well.

The method according to the invention comprises as a first step the placing of the ring module in the cylinder bore, where the ring module is pre-centered as the first support rails are hydraulically moved radially outwards by means of the fluid supply device. The ring module then moves completely into the cylinder bore with the tool head, so that the tool or the tool head respectively is accurately centered by the radial outward movement of the first and second support rails, which is caused hydraulically by means of the fluid supply device. Following the precise centering, when the central tool axis coincides with the central bore axis and this position is secured by the first and second support rails, the tool head is axially moved deeper into the bore within the ring module, and the cutting edge carrier is made to rotate. When the machining speed has been reached, the preset boring radius is adjusted by moving the cutting edges radially outwards using hydraulic power. The cylinder bore is then bored by an axial reverse traverse of the tool head with the cutting edges in the ring module. When the cylinder bore has been bored, first the tool head and then the ring module are retracted from the bore. The hydraulic outward movement of the support rails and the cutting edges respectively involves the supply of fluid by the fluid supply device to the respective adjusting device, whereby the support or cutting radius is increased.

The movement of the ring module into the cylinder bore is completed when the ring module contacts the bore lead-out if provided, the axial movement of the tool head in the ring module within the cylinder bore being stopped when the tool head contacts the bore lead-out.

For the boring of the cylinder bore, a predetermined feed rate of the drive is set at which the tool head is traversed axially back in the ring module. It is further conceivable that the second support rails may be released when the tool head reaches an intermediate region in the cylinder bore.

The above and further advantages are explained in the following description with reference to the accompanying figures. The reference to the figures is intended to support the description and to promote a better understanding of the subject matter. The figures are restricted to a diagrammatic representation of an embodiment of the invention.

Of the figures:

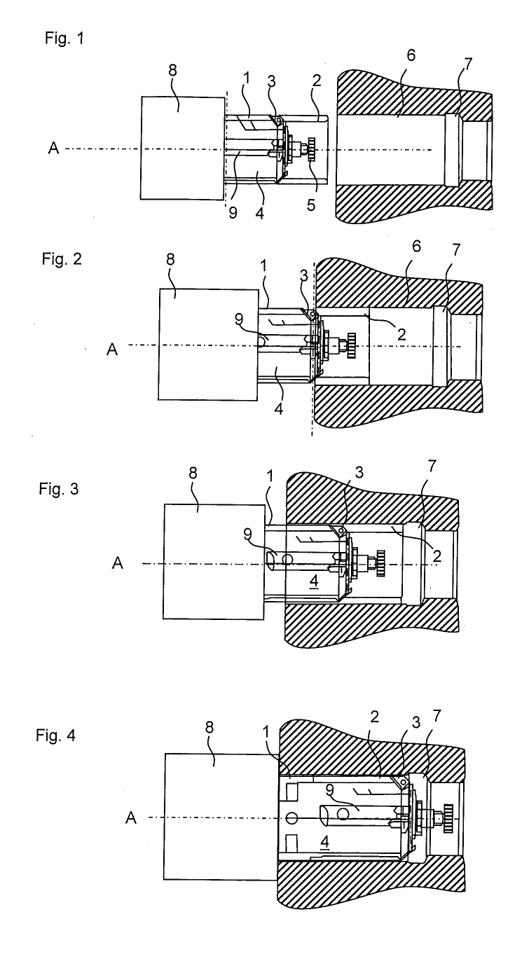

FIG. 1 is a lateral sectional view of the boring tool according to the invention and of a cylinder bore to be machines;

FIG. 2 is a view as in FIG. 1, showing a first process step;

FIG. 3 is a view as in FIG. 1, showing a second process step;

FIG. 4 is a view as in FIG. 1, showing a third process step;

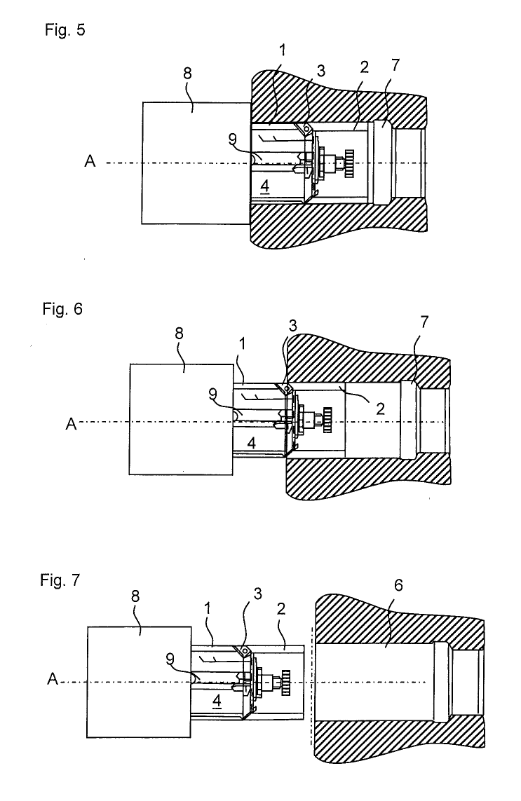

FIG. 5 is a view as in FIG. 1, showing a fourth process step;

FIG. 6 is a view as in FIG. 1, showing a fifth process step;

FIG. 7 is a view as in FIG. 1, showing a sixth process step.

The method and the boring tool according to the invention permit a precise boring of in particular thermally coated cylinders and replace the cost-intensive machining step of rough honing, which is currently used for arc-sprayed cylinder bores.

By self-centering within the still rough thermally coated cylinder sliding surface combined with precision-machining using the boring/precision turning process, a constant coating thickness can be ensured within the cylinder circumference and along the entire length of the cylinder sliding surface without any need for a highly accurate positioning of the tool or the component in the machining center. The method and the tool according to the invention are therefore particularly suitable for machining thermally coated cylinder bores, where precise centering is absolutely necessary owing to the thin LDS layer. The method and the tool offer particular advantages in the case of the cylinder bores of a V-engine, where too many degrees of freedom are present to allow precise centering by conventional tools and methods. The self-centering action of the boring tool permits the use of low-cost cutting materials, the defined cutting edges being moved outwards.

FIGS. 1 to 7 show a boring tool according to the invention in various steps of the method according to the invention. The tool, which can be mounted as a boring tool on a conventional machining center, comprises a tool carrier 8 and a tool head 4. The tool axis A-A coincides with the axis of rotation and should be in alignment with the axis of the cylinder bore 6. The tool head 4 comprises a cutting edge carrier with an adjusting device for the variable adjustment of the cutting radius of the inserts 3. The ring module concentrically surrounding the tool head 4 comprises first support rails 1 and second support rails 2, each of them provided with an adjusting device for the variable radial adjustment of the supporting radius. The adjusting devices for the first and second support rails 1, 2 and for the inserts 3 (of which only one can be seen in the drawing) are operatively coupled to a cooling lubricant supply device 9, so that the adjusting devices are operated in a quasi-hydraulic manner. The cooling lubricant supply device 9 is therefore not only used for the supply of cooling lubricant for a quick discharge of chips from the machining process and for cooling the workpiece, but also for moving the support rails 1, 2 and the inserts 3 outwards in the bore 6. In FIG. 1, the tool is placed outside the cylinder bore 6, the tool head 4 being retracted into the ring module. The tool head 4 is axially movable in the ring module.

In FIG. 2 the ring module is placed in the cylinder bore 6 without any rotation or coolant supply, whereupon the ring module is pre-centered in the cylinder bore 6 by the first support rails 2. The internal cooling lubricant supply device 9 increases the fluid pressure acting on the adjusting device of the first support rails 2, whereby the first support rails 2 are hydraulically moved radially outwards or “expanded”. The tool axis X-X is now in alignment with the bore axis; the tool is already centered.

The tool with the external ring module now moves completely into the cylinder bore 6, until the ring module contacts the boring lead-out 7, and the support rails 1,2 are extended under slight cooling lubricant pressure, so that the tool is now completely centered within the cylinder bore 6.

The tool head 4 is now moved axially in the ring module to the end of the bore 6 and into the boring lead-out 7, and the cutting edge carrier is made to rotate and accelerated to speed; in this process, all support rails 1, 2 are supported on the cylinder sliding surface to ensure the central position of the tool.

This is followed by driving the inserts 3 outwards by further increasing the cooling lubricant pressure until the cutting edges 3 have reached the preset boring radius. The cylinder sliding surface is now bored by moving the tool head 4 axially in the reverse direction at a defined rate, and when an inter-mediate region is reached as shown in FIG. 5, the second support rails 1 are released, so that the tool is now centered by the first support rails 2 only. Up to this point, the position of the ring module remains unchanged. From this intermediate region, the whole tool with its tool head 4 and ring module is evenly extracted from the cylinder bore 6 in the boring process (FIGS. 5 and 6).

The boring process and the tool according to the invention result in lower machining costs and shorter machining times and allow the more cost-effective use of a machining center instead of a honing machine. Thermally coated cylinder bores, such as those of a crankcase, where the coating is thin, can therefore be machined in a cost-effective manner.

1. A boring tool for cylinder bores (6), comprising a tool holder (8) and a tool head (4) with a cutting edge carrier with a rotary drive for at least one cutting edge (3), wherein a fluid supply device (9) is provided in the tool head (4),
wherein
the cutting edge carrier is provided with a first adjusting device for adjusting a variable cutting radius of the at least one cutting edge (3),
the boring tool comprises a ring module for first support rails (1), which concentrically surrounds the tool head (4), the ring module being provided with a second adjusting device for the variable radial adjustment of the supporting radius of the first support rails (1), and
second support rails, wherein the ring module is provided with a third adjusting device for the second support rails (2), the third adjusting device being provided for the variable radial adjustment of the supporting radius of the second support rails (2), wherein the second and third adjusting devices are operatively coupled to the fluid supply device (9) and wherein the tool head (4) is axially displaceable with respect to the ring module.

2. The boring tool according to claim 1, wherein the tool head (4) is further axially displaceable with respect to the tool holder (8) and wherein the fluid supply device (9) is preferably oriented axially.

3. The boring tool according to claim 1, wherein the ring module comprises at least three first and second support rails (1, 2) each, which are preferably spaced equidistantly along a circumference of the ring module.

4. The boring tool according to claim 1, wherein the cutting edge carrier comprises four cutting edges (3), which are spaced equidistantly along a circumference of the of the tool.

5. The boring tool according to claim 1, wherein the fluid is a cooling lubricant.

6. The boring tool according to claim 1, wherein the boring tool is a tool for machining thermally coated cylinder bores (6), wherein each cylinder bore (6) has a specified maximum diameter, a cylinder opening and an end which is remote from a cylinder opening, and wherein a spindle lead-out (7) with a diameter greater than a diameter of the cylinder bore (6) is provided at an end of the cylinder bore (6) which is remote from a cylinder opening.

7. A method for the boring of cylinder bores (6), comprising the following steps:
(a) providing a boring tool comprising a tool holder (8) and a tool head (4) with a cutting edge carrier with a rotary drive for at least one cutting edge (3), wherein a fluid supply device (9) is provided in the tool head (4), wherein the cutting edge carrier is provided with a first adjusting device for adjusting a variable cutting radius of the at least one cutting edge (3), the boring tool comprising a ring module for first support rails (1), which ring module concentrically surrounds the tool head (4), the ring module further being provided with a second adjusting device for the variable radial adjustment of the supporting radius of the first support rails (1), the ring module further comprising second support rails, wherein the ring module is provided with a third adjusting device for the second support rails (2), the third adjusting device being provided for the variable radial adjustment of the supporting radius of the second support rails (2), and wherein the second and third adjusting devices are operatively coupled to the fluid supply device (9) and wherein the tool head (4) is axially displaceable with respect to the ring module,
(b) positioning the ring module in the cylinder bore (6) of a cylinder to be machined,
(c) pre-centering the ring module in the cylinder bore (6) by moving the first support rails (1) radially outwards hydraulically by means of the fluid supply device (9),
(d) complete insertion of the ring module and the tool head (4) into the cylinder bore (6),
(e) centering the tool in the cylinder bore (6) by moving the first and second support rails (1, 2) radially outwards hydraulically by means of the fluid supply device (9),
(f) moving the tool head (4) axially deeper into the bore within the ring module and rotating the rotary drive of the cutting edge carrier,
(g) adjustment to a preset boring radius by moving the at least one cutting edge (3) radially outwards by hydraulic power,
(h) boring of the cylinder bore (6) with moving the tool head (4) axially in the reverse direction in the ring module,
(i) extraction of the tool head (4) from the bore (6) and the extraction of the ring module from the bore (6).

8. The method according to claim 7, wherein the hydraulic radial outward movement of the at least one cutting edge (3) involves the feed of fluid by the fluid supply device (9) to one or more of the first, second and third adjusting devices and the increase of the respective support and/or cutting radius.

9. The method according to claim 7, comprising the following steps: insertion of the ring module and the tool head (4) into the cylinder bore (6), contacting the bore lead-out (7) with the ring module, and, if the tool head (4) is axially extended within the ring module, contacting the bore lead-out (7) by the tool head (4).

10. A method according to claim 7, comprising the following steps:
before the boring of the cylinder bore (6), adjusting to a preset feed rate of a drive which axially withdraws the tool head (4) in the reverse direction in the ring module, and
when the tool head (4) reaches an intermediate region of the cylinder bore (6), release of the second support rails (2).

11. The boring tool according to claim 1, wherein the cutting edge carrier comprises four inserts with cutting edges (23), which are spaced equidistantly along a circumference of the of the tool.

12. The boring tool according to claim 1, wherein the boring tool is a tool for machining arc-sprayed cylinder bores (6), wherein each cylinder bore (6) has a specified maximum diameter, a cylinder opening and an end which is remote from a cylinder opening, and wherein a spindle lead-out (7) with a diameter greater than a diameter of the cylinder bore (6) is provided at an end of the cylinder bore (6) which is remote from a cylinder opening.
